(19) United States
(12) Patent Application Publication
(10) Pub. No.: US 2014/0189537 A1
(43) Pub. Date: Jul. 3, 2014

(54) Framework and method for dynamic talker ID based media treatment in a group communication

(71) Applicant: QUALCOMM INCORPORATED, San Diego, CA (US)

(72) Inventors: Sandeep Sharma, San Diego, CA (US); Mohammed Ataur R. Shuman, San Diego, CA (US); Amit Goel, San Diego, CA (US)

(73) Assignee: QUALCOMM Incorporated, San Diego, CA (US)

(21) Appl. No.: 13/733,232

(22) Filed: Jan. 3, 2013

(51) Int. Cl. G06F 3/0481; G06F 3/048

(52) U.S. Cl. CPC G06F 3/0481
USPC 715/753

(57) ABSTRACT

A framework is provided that enables a group communication session participant to specify the manner in which his or her computing device handles/renders media received from other group communication session participants based on the identity of the sender of the media. The various embodiments enable the group communication participant to manage the presentation of media on the various interfaces of his or her computing device based on both the type of the received media and the sender ID (i.e., talker ID) associated with the received media. In an embodiment, the user may be enabled to dynamically switch the media handling settings during a group communication session.

### BACKGROUND

Computing devices, such as smart phones, tablet computers, and laptop computers, that enable a participant (i.e., a user) to participate in a group communication session may include multiple interfaces for presenting media to the participant. Example interfaces include a display of the device, an earphone or external speaker connected to an earphone (i.e., RJ10 standard headphone jack) port of the device, a speakerphone speaker, a telephone speaker, an earpiece connected by a Bluetooth® connection to a Bluetooth® port of the device; and an external projection display connected by a Universal Serial Bus (“USB”) connection to a USB port of the device. In current group communication sessions various different types of media, such as audio data, pictures, video, and text messages may be exchanged between the participants (i.e., users) during the group communication session.

Current computing devices treat all media received in a group communication session the same without regard to the identity of the sender of the media. No matter the sender, current devices provide all the received media to a default or single-user selected interface (e.g., a Bluetooth® earpiece or the device display) based only on media type. For example, any picture or text message received during the group communication session will be provided to the default display, such as the display screen of the device, regardless of the identity of sender of the picture or text message.

### SUMMARY

The systems, methods, and devices of the various embodiments provide a framework that enables a user of a computing device participating in a group communication session to specify the manner in which his or her mobile device handles/renders media received from other group communication session participants based on the identity of the sender of the media. The various embodiments enable the group communication participant to manage the presentation of media on the various interfaces of his or her computing device based on both the type of the received media and the sender ID (i.e., talker ID) associated with the received media. In an embodiment, the user may be enabled to dynamically switch the media handling settings during a group communication session.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with the various embodiments.

FIG. 2 is a process flow diagram illustrating an embodiment method for managing the presentation of media on a computing device during a group communication session.

FIG. 3 is a process flow diagram illustrating an embodiment method for managing the presentation of media on a computing device based on sender ID and media type.

FIG. 4 is a data structure diagram illustrating potential elements of a presentation rule look-up table.

FIG. 5 is a process flow diagram illustrating an embodiment method for enabling user configuration of presentation rules during a group communication session.

FIG. 6 is a process flow diagram illustrating an embodiment method for re-configuring presentation rules in response to interface changes during a group communication session.

FIG. 7 is a process flow diagram illustrating an embodiment method for dynamically updating presentation rules based on previous presentations of media by the computing device.

FIG. 8 is a component diagram of an example mobile device suitable for use with the various embodiments.

FIG. 9 is a component diagram of another example mobile device suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “mobile device,” “computing device,” and “participant device” are used interchangeably herein to refer to any one or all of cellular telephones, smart phones, personal or mobile multi-media players, personal data assistants (PDA's), laptop computers, tablet computers, smart books, palm-top computers, wireless electronic mail receivers, multimedia Internet enabled cellular telephones, wireless gaming controllers, and similar personal electronic devices which include a programmable processor and memory and circuitry for participating in a group communication session and handles/renders media received from other group communication session participants.

The various embodiments provide a framework which enables a group communication session participant to specify the manner in which his or her computing device handles/renders media received from other group communication session participants based on the identity of the sender of the media. The various embodiments enable the group communication participant to manage the presentation of media on the various interfaces of his or her computing device based on both the type of the received media and the sender ID (i.e., talker ID) associated with the received media. In an embodiment, the user may be enabled to dynamically switch the media handling settings during a group communication session.

In an embodiment a group communication (e.g., group voice or video call) participant to may establish rules specifying the treatment of media received from other users in a group communication session on a per user basis. In a group communication session, each participant may be assigned a unique user ID (i.e., talker ID), such as their telephone number (i.e., caller ID), a MAC ID of the computing device, or an ID assigned by a group communication server. During the group communication session, each user ID may be attached to in-session signaling used to transmit media to other participants. Thus, in a group communication session, when media data is sent by a sender, the user ID of the sender may be included with the media data (i.e., the sender ID is provided with the media data when transmitted). The various embodiments leverage the sender IDs that are received with media during the group communication session to enable a recipient to govern how the recipient's computing device presents media received from specific sender ID's (i.e., from specific participants in the group communication session).

In an embodiment, a group call participant may establish media presentation rules on his or her computing device that depend upon the type of media received and the sender ID. In an embodiment, the presentation rules may specify actions to be executed by the computing device to present (or ignore) media received from particular sender ID(s). In an embodiment, the presentation rules may specify the interface to be used to present the media, such as the display, ear phone, speakerphone, port, application, auxiliary device, etc. As an example, a presentation rule established on a User A's computing device might specify that when visual media (e.g., a photo or a video clip) is received with a sender ID associated with User B the images are to be presented on the standard display of User A's computing device. As another example, a presentation rule established on User A's computing device might specify that when visible media is received with a sender ID associated with User C the images are to be presented on a connected auxiliary display device, such as a connected external projector. In this manner, User A may specify that media received from User B is displayed on a different device than media received from User C using the sender ID included with the received media. As a third example, a presentation rule established on a User A's computing device may specify that audible media received from User D is to be played on the speakerphone while audio from other participants should be played on a Bluetooth® earpiece.

In the various embodiments, presentation rules may depend on the media type and presentation modalities may be specified based on both the sender ID and the media type. Thus, pictures and video may be presented on different displays for individual senders, and sounds from videos may be rendered on one speaker while telephone call sounds may be rendered by another speaker. Media types may be defined based on any relevant characteristic and/or metadata associated with received media that may be leveraged to distinguish categories of media and presentation rules governing the handling/rendering of those categories of media. Media types may include, pictures, text messages, videos, sounds, multi-purpose internet mail extensions (MIMEs), resolutions, formats, file extensions, etc.

In an embodiment, a computing device may identify a sender ID, a media type, and a presentation rule, and present received media data via an interface selected based on applying the Sender ID and media type to the presentation rule. As an example, Users A, B, C, D, and E may be in a group communication session. As part of the signaling during the group communication session, the group communication server may provide the sender IDs for each of the user's to Users A, B, C, D, and E (such as each device's telephone number). During the group communication session User B may send media data to the other Users A, C, D, and E in the group session and User A's computing device may receive the media data from the group communication server. User A's computing device may identify the sender ID (i.e., talker ID) associated with the received media data. User A's computing device may identify the sender ID such as from header data included in the media data itself. As an example, media data sent by User B may include User B's sender ID in the media header data. In another embodiment, User A's computing device may identify the sender ID based on signaling from the group communication server received prior to or during receipt of the media data. User A's computing device may identify a media type of the received media data. In an embodiment, User A's computing device may identify the media type of the received media data based on information in the data packets of the received media data, such as header information for a file extension indicating the media type. As an example, User A's computing device may identify that the received media type is a picture based on header information in the received media data or a file extension (e.g., .gif, .jpg, etc.). User A's computing device may identify a presentation rule associated with the identified sender ID and select an interface of User A's computing device based on the identified presentation rule. In an embodiment, a look-up table correlating sender IDs, media types, and presentation rules may be stored in a memory of User A's computing device, and User A's computing device may identify the presentation rule associated with the sender ID and media type by locating an entry in the look-up table corresponding to the identified sender ID and media type. In an embodiment, the presentation rule may indicate the interface on which received media should be rendered for each sender ID and media type. In an embodiment, the presentation rule may indicate more than one interface on which received media should be rendered in parallel for each sender ID and media type.

If user B's computing device sends a picture, User A's computing device may use a look-up table to identify the presentation rule 1 corresponding to receiving picture type media data from the sender ID of User B. The presentation rule 1 may indicate that pictures from User B are to be displayed only on the main display of User A's computing device. In response, User A's computing device may select the main display for presentation of the received media data. User A's computing device may present the received media data via the selected interface.

In an embodiment, the presentation rules for each participant's respective computing device may be dynamically changed during a group communication session by that participant. In an embodiment, during a group communication session the participant's computing device may present a graphical user interface enabling the participant to apply and modify their previously established presentation rules as the group communication session progresses. Embodiments may include user interfaces that enable the user to easily set up presentation rules for users and media types. In an embodiment, the presentation rules may enable control of media when the media is received without an associated sender ID. As an example, the presentation rules may provide a default presentation format, such as on the main display, when a sender ID cannot be associated with the received media.

In an embodiment, presentation rules may be multiple scenario rules enabling the user to create tiered media handling settings. The multiple scenario rules may be user defined rules which prioritize media handling based on more than one factor, including participant device settings, connected peripheral devices, group communication settings, etc. As an example, a multiple scenario rule may indicate that received audio media is supposed to be played over an attached ear piece when the ear piece is present, but when the ear piece is not present the audio media should not be played.

In an embodiment, the receiving participant device may send information to other group communication members indicating how the received media was presented by the receiving participant device. As an example, the receiving participant device may send an indication of the resolution at which a video clip was presented. The indication of how the media was presented may be sent only to the originating device, sent to a portion of the group communication member devices, or may be sent to all group communication member devices.

In an embodiment, presentation rules may be dynamically updated based on previous presentations of media by the participant device. In this manner, machine learning techniques may be applied to the presentation rules to modify future presentations based on past presentations.

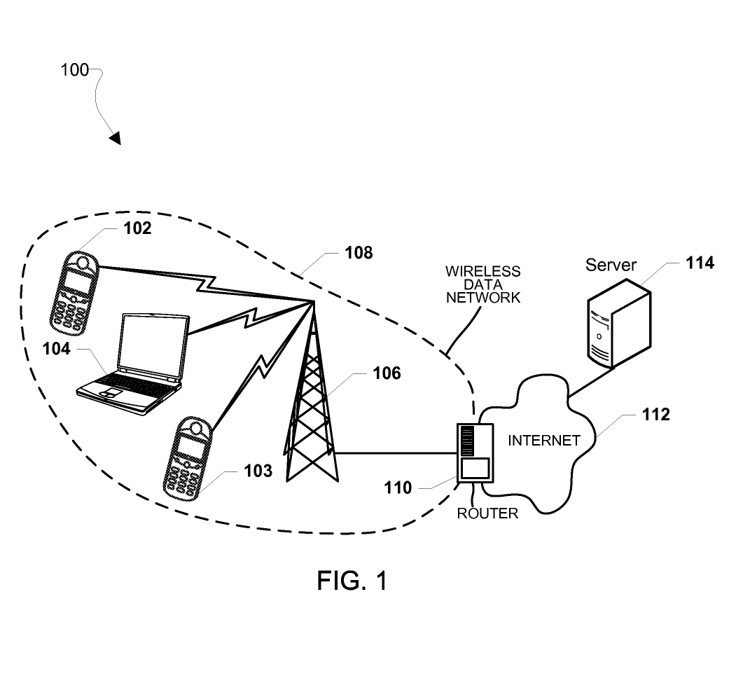

FIG. 1 illustrates a wireless network system 100 suitable for use with the various embodiments. Computing devices 102, 103, and 104 and a wireless transmitter/receiver 106 together make up a wireless data network 108. Using the wireless data network 108, data may be transmitted wirelessly between the computing devices 102, 103, and 104 and the wireless cell tower or base station 106. The transmissions between the computing devices 102, 103, and 104 and the wireless cell tower or base station 106 may be by any cellular networks, including Wi-Fi, CDMA, TDMA, GSM, PCS, G-3, G-4, LTE, or any other type connection. The wireless network 108 may be in communication with a router 110 which connects to the Internet 112. In this manner data may be transmitted from/to the computing devices 102, 103, and 104 via the wireless network 108, and router 110 over the Internet 112 to/from a server 114 by methods well known in the art. While the various embodiments are particularly useful with wireless networks, the embodiments are not limited to wireless networks and may also be implemented over wired networks with no changes to the methods.

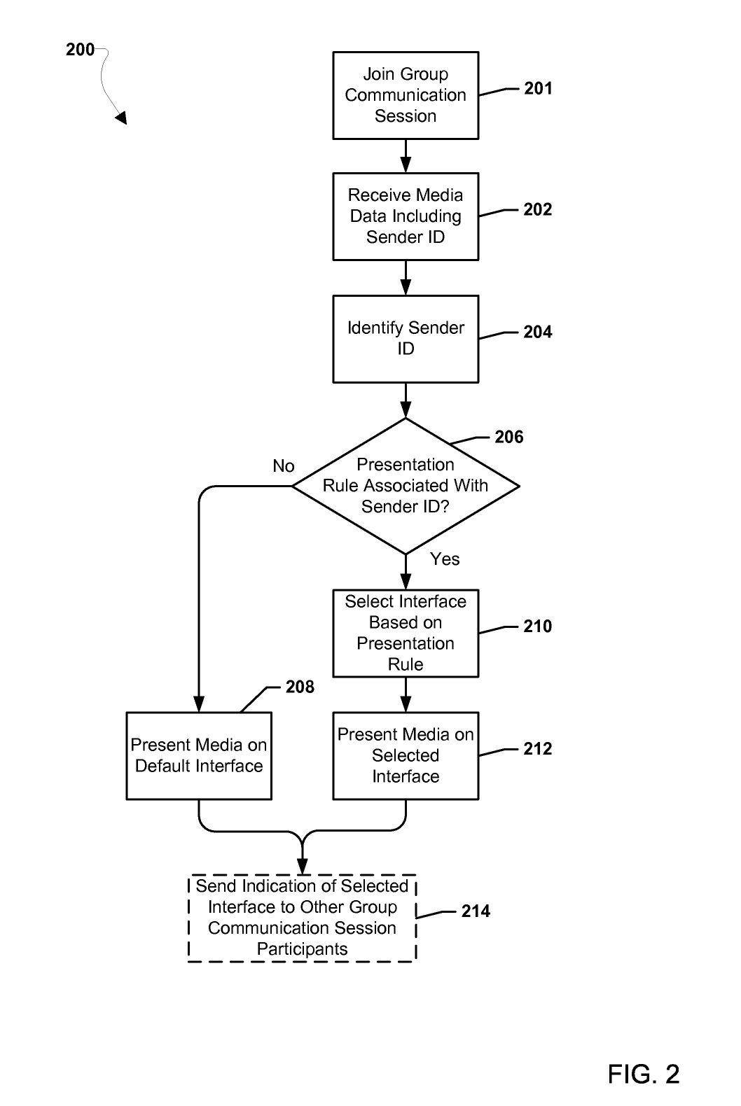

FIG. 2 illustrates an embodiment method 200 for managing the presentation of media on a computing device during a group communication session. In an embodiment, the operations of method 200 may be performed by the processor of a computing device (e.g., a smart phone). In block 201 the computing device processor may join the group communication session. A group communications session may be any type communication session in which two or more user devices may exchange media data, including group voice calls, group data calls, push-to-talk group sessions, push-to-share group sessions, etc. In an embodiment, as part of joining a group communication session the computing device processor may exchange information with a group communication server. In a group communication session each participant in the group communication may be assigned a user identification (user ID) (i.e., talker ID), such as the telephone number of the computing device (i.e., caller ID), MAC ID of the computing device, or an ID assigned by the group communication server. During a group communication session, each user ID may be attached to in-session signaling used to transmit media to other participants in the group communication. When a participant in a group communication sends media data, the user ID of the sending participant may be an identifier of the sender (“sender ID”). In block 202 the computing device processor may receive media data including an identifier of the sender (“sender ID”). In an embodiment, the sender ID may be included in header information associated with the received media data. In another embodiment, the sender ID may be included in initial messaging received by the computing device in preparation for receiving the media data. In block 204 the computing device processor may identify the sender ID associated with the received media data. As examples, the computing device processor may identify the sender ID associated with the received media data by inspecting header information included in the media data and/or inspecting initial messages received as part of the receiving the media data.

In determination block 206, the computing device processor may identify whether a presentation rule is associated with the identified sender ID. In an embodiment, identifying a presentation rule may include comparing the sender ID to a data table correlating sender IDs and presentation rules to determine whether the sender ID is listed in the data table. In another embodiment, presentation rules may be associated with contacts in an address book resident in a memory of the computing device, and identifying a presentation rule may include identifying whether the sender ID corresponds to an address book entry and identifying whether the address entry includes a presentation rule. If a presentation rule is not associated with the sender ID (i.e., determination block 206=“No”), in block 208 the computing device processor may present the media on a default interface of the computing device. As an example, a default interface may be one or more of a display, an ear phone, speakerphone, a port, an application, or an auxiliary device connected to the computing device on which received media will be output when no presentation rule is identified.

If a presentation rule is associated with the sender ID (i.e., determination block 206=“Yes”), in block 210 the computing device processor may select an interface of the computing device for presenting the media based on the identified presentation rule. In an embodiment, the presentation rule may be a unitary scenario rule directly establishing one action for handling media. As an example, a presentation rule may indicate that the media should be presented on the main display of the computing device. As another example, a presentation rule may indicate that the media should be sent to an auxiliary connected device, such as a projector. As a further example, a presentation rule may indicate that the media should be presented on the main display and a secondary display of the computing device simultaneously. In a further embodiment, the presentation rule may be a multiple scenario rule enabling the user to create tiered media handling settings. The multiple scenario rules may be user defined rules which prioritize media handling based on more than one factor, including participant device settings, connected peripheral devices, group communication settings, etc. As an example, a multiple scenario rule may be an if-then type rule, indicating that received audio media is supposed to be played over an attached earpiece when the earpiece is present, but when the earpiece is not present the audio media should not be played. In block 212 the computing device processor may present the media on the selected interface of the computing device. The selected interface may be one or more of a display, an ear phone, speakerphone, a port, an application, or an auxiliary device connected to the computing device, such as a projector.

In an optional embodiment, in optional block 214 the computing device processor may send an indication of the selected interface to other group communication session participants. In an embodiment, the indication of the selected interface may be information indicating the type of interface, the characteristics of the interface (e.g., resolution, size, audio performance frequency characteristics, etc.), any changes made in presenting the media (e.g., not playing audio while still presenting video), etc. In an embodiment, the indication may be sent only to a device associated with the sender (i.e., user) associated with the sender ID. In another embodiment, the indication may be sent to a portion of the other computing devices participating in the group communication session, such as all other computing devices participating in the group communication session. The sending of an indication of the selected interface may enable sending devices to better tailor their future transmission of media to conform to the presentation rules. For example, a sender may receive an indication that a media clip is being presented on a very small screen and may adjust the resolution of future media clips accordingly.

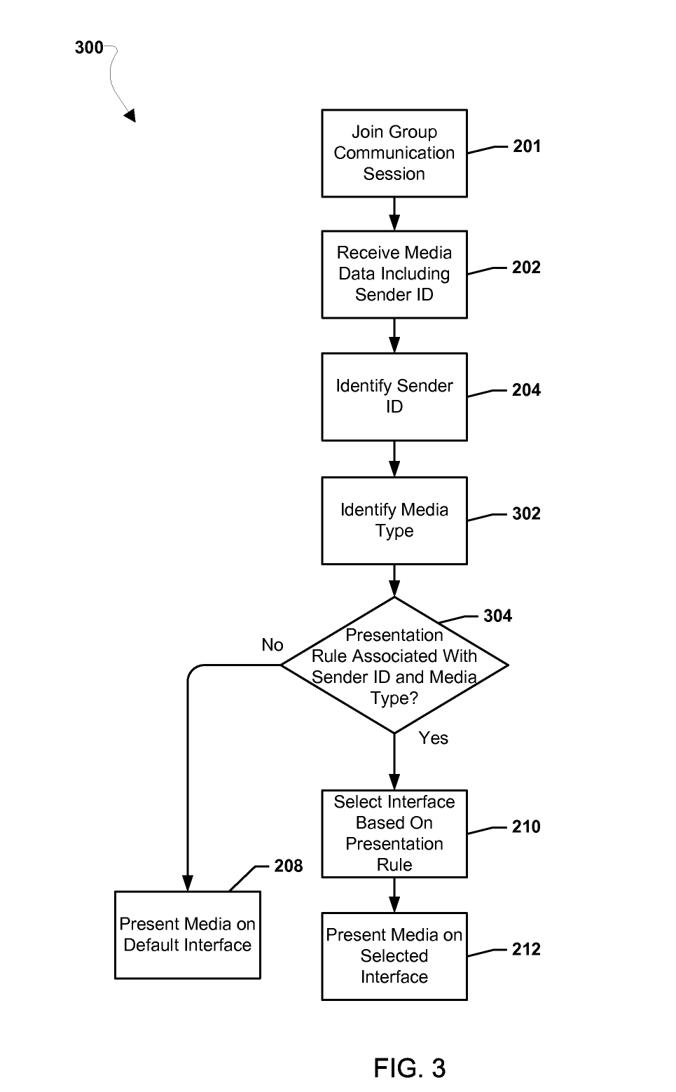

FIG. 3 illustrates an embodiment method 300 similar to method 200 described above with reference to FIG. 2, except that in method 300 presentation of received media is managed based on sender ID and media type. In an embodiment, the operations of method 300 may be performed by the processor of a computing device (e.g., a smart phone). As discussed above, in blocks 201, 202, and 204 the computing device processor may perform operations to join a group communication session, receive media data during the group communication session including a sender ID, and identify the sender ID associated with the received media data. In block 302 the computing device processor may identify a media type of the received media data. In an embodiment, the computing device processor may identify a media type based on information in the data packets of the received media data, such as header information or a file extension indicating the media type. As an example, the computing device may identify that the received media data is a picture based on the file extension (e.g., .gif, .jpg, etc.). In determination block 304 the computing device processor may identify whether a presentation rule is associated with the identified sender ID and the identified media type. In an embodiment, identifying a presentation rule may include comparing the sender ID to a data table correlating sender IDs, media types, and presentation rules to determine whether the sender ID and the media type are listed in the data table. If a presentation rule is not associated with the sender ID and the media type (i.e., determination block 304=“No”), as discussed above, in block 208 the computing device processor may present the media on a default interface of the computing device. If a presentation rule is associated with the sender ID and media type (i.e., determination block 304=“Yes”), as discussed above, in block 210 the computing device processor may select an interface of the computing device for presenting the media based on the identified presentation rule and in block 212 the computing device processor may present the media on the selected interface of the computing device.

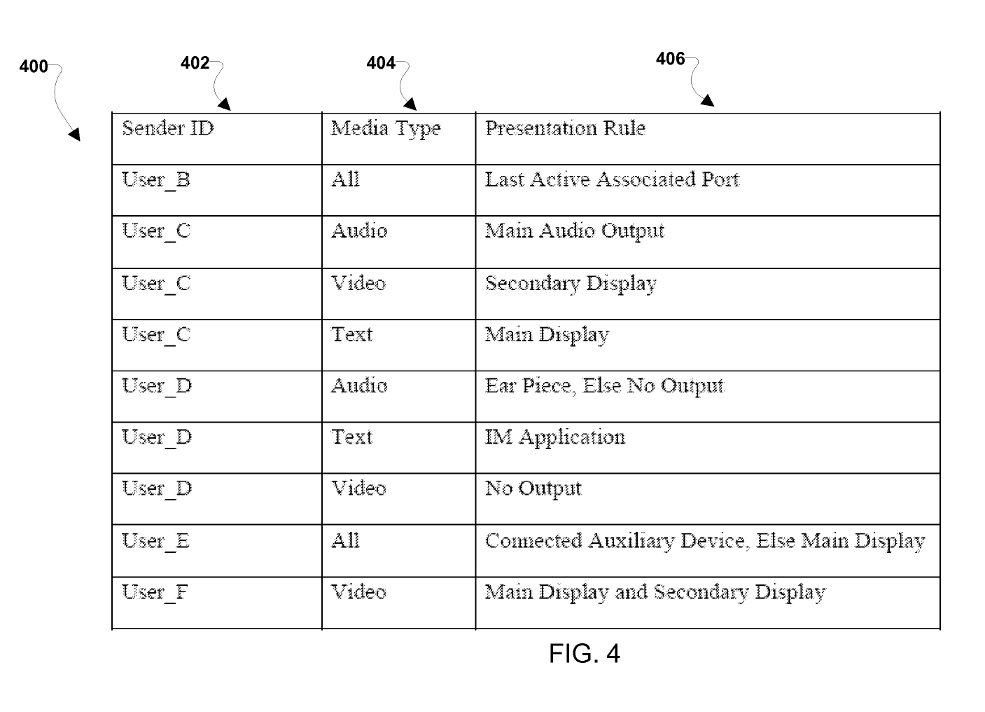

FIG. 4 is a data structure diagram illustrating potential elements of a presentation rule look-up table 400. In an embodiment, the presentation rule look-up table 400 may be stored in a memory of the computing device. In an embodiment, the presentation rule look-up table 400 may be user configurable, including user configurable during a group communication session. The presentation rule look-up table 400 may correlate sender IDs 402, media types 404, and presentation rules 406. The associations between sender IDs 402, media types 404, and presentation rules 406 in the presentation rule look-up table 400 may enable a computing device to manage the presentation of media on the computing device during a group communication session. Sender IDs 402 may be included for one or more users, for example User_B, User_C, User_D, User_E, and User_F. Sender IDs 402 may be repeated for different users to enable the inclusion of different presentation rules 406 based on different media types 404 for the same user. Media types 404 include general media type indications, such as All, Audio, Video, or Text, and/or may be specific media type indications, such as file types (e.g., .gif, .jpg, .wav, etc.). Presentation rules 406 may be unitary rules, such as “Last Active Associated Port”, “Main Audio Output”, “Secondary Display”, “Main Display”, “IM Application”, “No Output”, or “Main Display and Secondary Display.” Additionally, presentation rules 406 may be multiple scenario rules, such as “Ear Piece, Else No Output” or “Connected Auxiliary Device, Else Main Display.”

A computing device receiving media data during a group communication session may identify the sender ID 402 associated with the received media data, identify the media type 404 of the received media data, and use the presentation rule look-up table 400 to identify a presentation rule 406 associated with the sender ID 402 and the media type 404. As an example, the sender ID 402 may be identified as User_B and the media type 404 may be identified as a video. Using the presentation rule look-up table 400 the computing device processor may identify that the corresponding presentation rule 406 is to present the video on “the last active associated port.” Based on this presentation rule 406, the computing device processor may select the last active associated port as the interface for presenting the video and present the video accordingly. As another example, the sender ID 402 may be identified as User_C. User_C may be associated with multiple presentation rules 406 based on the media type 404. When the media type 404 is identified as an audio clip, the presentation rule 406 of “main audio output” may be identified, and the computing device processor may select the main audio output, such as the ear phone speaker of a smart phone, as the interface to present the audio clip. When the media type 404 is identified as a video clip, the presentation rule 406 of “secondary display” may be identified, and the computing device processor may select the secondary display as the interface to present the video clip. When the media type 404 is identified as a text message, the presentation rule 406 of “main display” may be identified, and the computing device processor may select the main display as the interface to present the text message. As another example, the sender ID 402 may be identified as User_D. User_D may be associated with multiple presentation rules 406 based on the media type 404. When the media type 404 is identified as an audio clip, the presentation rule 406 of “earpiece, else no output” may be identified. The computing device processor may determine whether an earpiece is connected to the computing device. If an earpiece is connected, the audio clip may be presented via the earpiece. If an earpiece is not connected, no audio output may be authorized and the audio clip may not be played. When the media type 404 is identified as a text message, the presentation rule 406 of “IM application” may be identified, and the computing device processor may select an IM application as the interface to present the text message. The computing device processor may launch the IM application and present the text message within the IM application. When the media type 404 is identified as a video clip, the presentation rule 406 of “no output” may be identified, and the computing device processor may not select an interface because the presentation rule 406 does not authorize playing of video. As a further example, the sender ID 402 may be identified as User__E and the media type 404 may be identified as a video. Using the presentation rule look-up table 400 the computing device processor may identify that the corresponding presentation rule 406 is to present the video on “connected auxiliary device, else main display.” Based on this presentation rule 406, the computing device processor may determine whether a connected auxiliary device is present, such as a projector. If an auxiliary device is present, the computing device processor may select the auxiliary device as the interface on which to present the video. If an auxiliary device is not present, the computing device processor may present the video on the main display of the computing device, select the last active associated port as the interface for presenting the video, and present the video accordingly. As another example, the sender ID 402 may be identified as User__F and the media type 404 may be identified as a video. Using the presentation rule look-up table 400 the computing device processor may identify that the corresponding presentation rule 406 is to present the video on the “main display and secondary display.” Based on this presentation rule 406, the computing device processor may select both the main display and secondary display as the interfaces to display the video and may present the video on both displays.

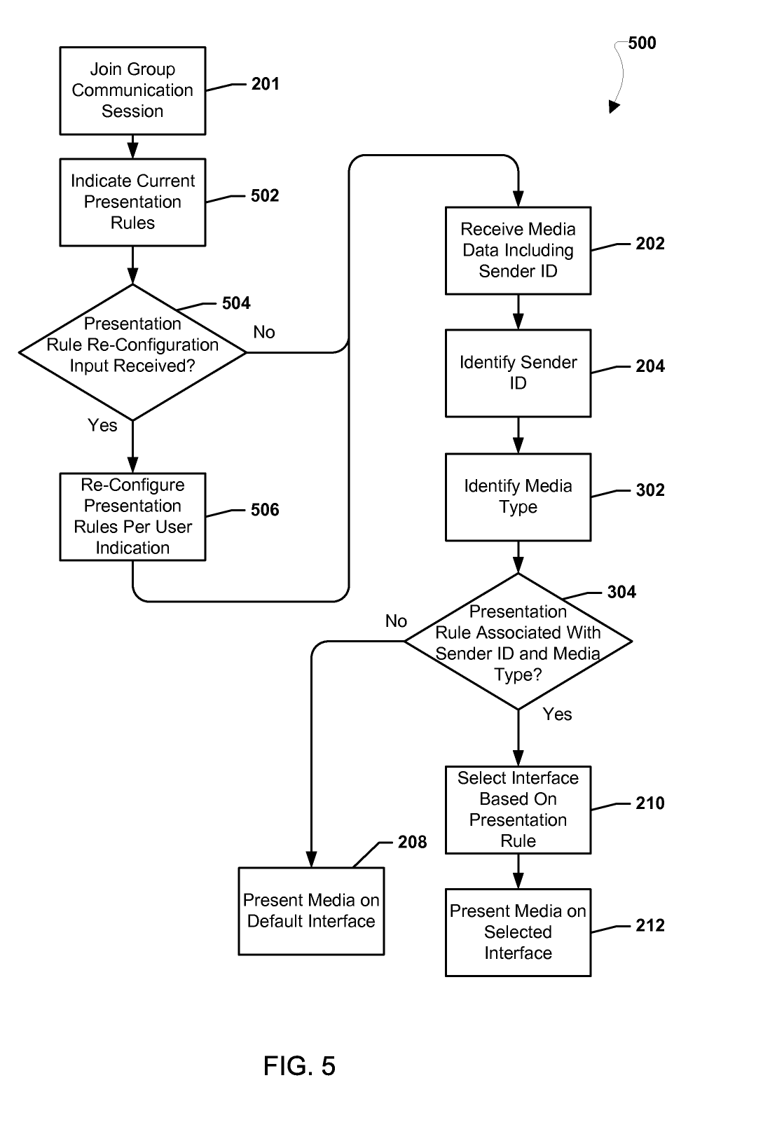

FIG. 5 illustrates an embodiment method 500, similar to method 300 described above with reference to FIG. 3, except that method 500 may enable user configuration of presentation rules dynamically during a group communication session. In an embodiment, the operations of method 500 may be performed by the processor of a computing device (e.g., a smart phone). As discussed above, in block 201 the computing device processor may join the group communication session. In block 502 the computing device processor may indicate the current presentation rules. In an embodiment, the current presentation rules may be indicated via a display to the user, such as a display of a pop-up menu during the group communication session, display of an icon indicating rules, or any other user perceptible indication. In this manner, the user may be notified of the current presentation rule settings, and may be given an opportunity to re-configure the presentation rules. In determination block 504 the computing device processor may determine whether a user input is received indicating that a presentation rule should be re-configured. In an embodiment, a presentation rule re-configuration indication may be an input from the user of the computing device indicating a desire to change one or more of the presentation rules. As an example, a presentation rule re-configuration indication may change the media type and/or change the interfaces on which media is to be displayed for one or more sender IDs. If a presentation rule re-configuration input is not received (i.e., determination block 504=“No”), in blocks 202, 204, 302, 304, 210, 208, and 212 the computing device processor may perform operations of like numbered blocks of method 300 described above with reference to FIG. 3. If a presentation rule re-configuration user input is received (i.e., determination block 504=“Yes”), in block 506 the computing device processor may re-configure the presentation rules per the user indication. In this manner, the presentation rule may be user configurable during the group communication session. In blocks 202, 204, 302, 304, 210, 208, and 212 the computing device processor may perform operations of like numbered blocks of method 300 described above with reference to FIG. 3, except that the re-configured presentation rules may be used to select the interface on which to present the received media. While illustrated as occurring before receiving media data, the operations of blocks 502, 504, and 506 may be performed at any time during the group communication session, and subsequently received media may be presented based on the re-configured presentation rules.

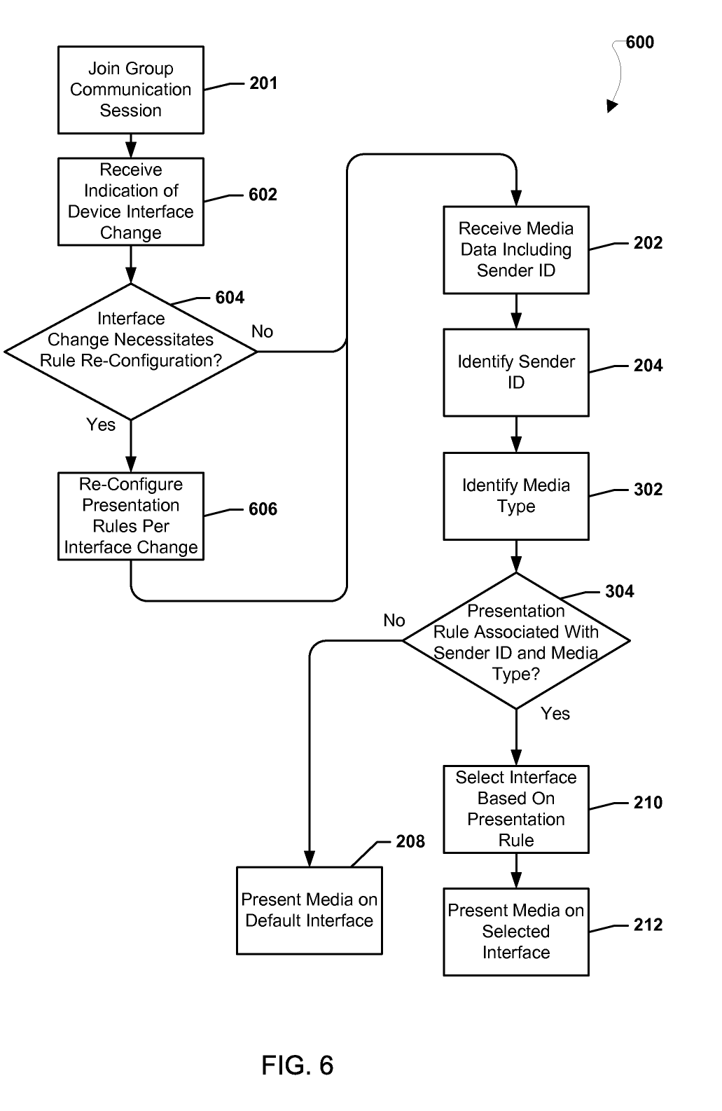

FIG. 6 illustrates an embodiment method 600, similar to method 300 described above with reference to FIG. 3, except that method 600 may enable re-configuring presentation rules in response to interface changes during a group communication session. In an embodiment, the operations of method 600 may be performed by the processor of a computing device (e.g., a smart phone). As discussed above, in block 201 the computing device processor may join the group communication session. In block 602 the computing device processor may receive an indication of a device interface change. An indication of a device interface change may be an indication that a status of an interface has changed, such as an indication that an application has opened or closed, a display has been added or removed, an auxiliary device has been connected or disconnected, a port has been activated or deactivated, etc. In determination block 604, the computing device processor may determine whether the interface change necessitates a rule re-configuration. As an example, an indication that an earpiece has been removed may result in the computing device processor determining that all rules which direct output of audio to the earpiece may need to be modified to direct output of audio via the main speaker. If a presentation rule re-configuration is not necessary (i.e., determination block 604=“No”), in blocks 202, 204, 302, 304, 210, 208, and 212 the computing device processor may perform operations of like numbered blocks of method 300 described above with reference to FIG. 3. If a presentation rule re-configuration is necessary (i.e., determination block 604=“Yes”), in block 606 the computing device processor may re-configure the presentation rules per the interface change. In this manner, the presentation rule may be dynamically modified during the communication session based on changes in device interfaces. In blocks 202, 204, 302, 304, 210, 208, and 212 the computing device processor may perform operations of like numbered blocks of method 300 described above with reference to FIG. 3, except that the re-configured presentation rules may be used to select the interface on which to present the received media. While illustrated as occurring before receiving media data, the operations of blocks 602, 604, and 606 may be performed at any time during the group communication session, and subsequently received media may be presented based on the re-configured presentation rules.

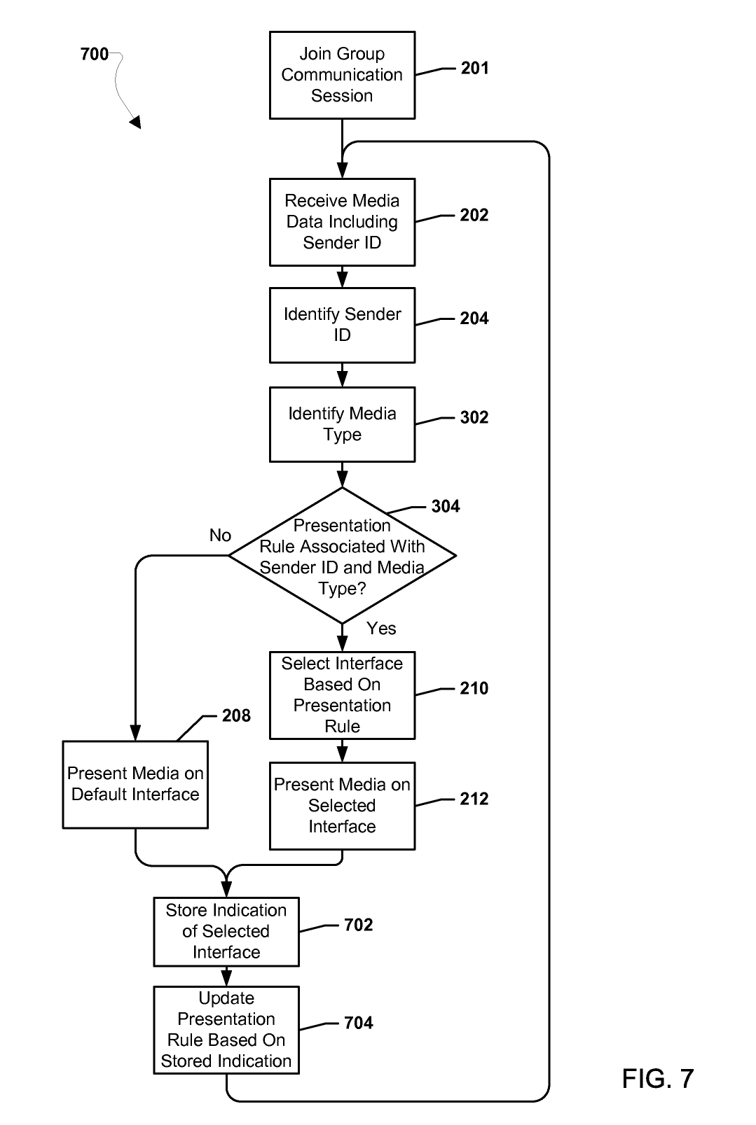

FIG. 7 illustrates an embodiment method 700, similar to method 300 described above with reference to FIG. 3, except that in method 700 presentation rules may be dynamically updated based on previous presentations of media by the computing device. In an embodiment, the operations of method 700 may be performed by the processor of a computing device (e.g., a smart phone). In blocks 201, 202, 204, 302, 304, 208, 210, and 212 the computing device processor may perform operations of like numbered blocks of method 300 described above with reference to FIG. 3. In block 702 the computing device processor may store an indication of the selected interface used to present the media in a memory of the computing device. As an example, a value in a hash table corresponding to the selected interface may be incremented based. In block 704 the computing device processor may update the presentation rule based at least in part on the stored indication of the selected interface. In this manner, an updated presentation rule may be generated. In blocks 202, 204, 302, 304, 210, 208, and 212 the computing device processor may perform operations of like numbered blocks of method 300 described above with reference to FIG. 3, except that the updated presentation rule may be used to select the interface on which to present the received media. In this manner, as media is received and presented, presentation rules may be dynamically updated enabling the computing device to apply machine learning techniques to improve future media presentations.

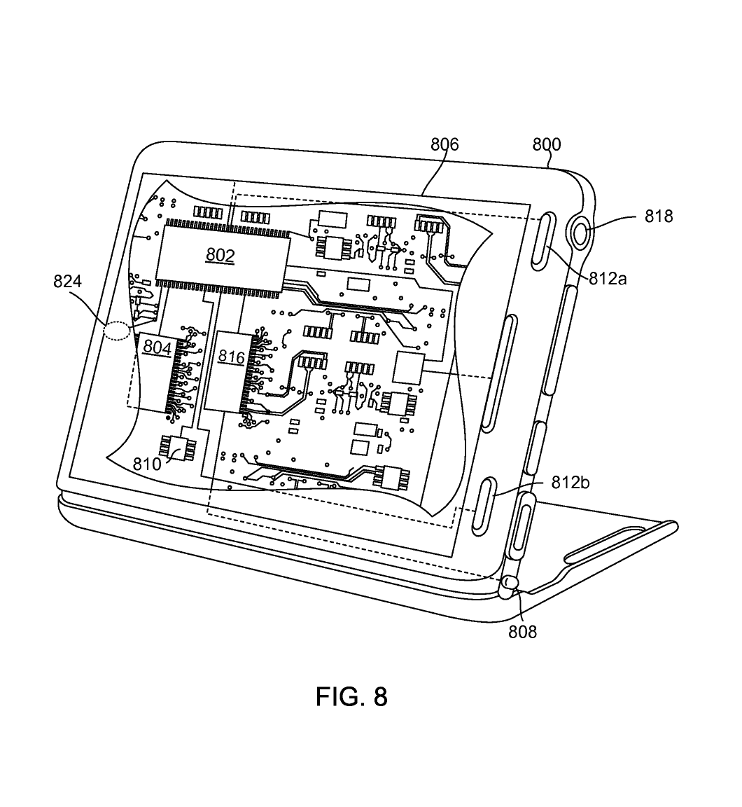

The various embodiments may be implemented in any of a variety of computing devices, an example of which is illustrated in FIG. 8. For example, the computing device may be a wireless device 800 (e.g., a smart phone). Wireless device 800 may include a processor 802 coupled to internal memories 804 and 810. Internal memories 804 and 810 may be volatile or non-volatile memories, and may also be secure and/or encrypted memories, or unsecure and/or unencrypted memories, or any combination thereof. The processor 802 may also be coupled to one or more touch screen displays 806, such as a resistive-sensing touch screen, capacitive-sensing touch screen infrared sensing touch screen, or the like. Additionally, the display of the wireless device 800 need not have touch screen capability. Additionally, the wireless device 800 may have one or more antenna 808 for sending and receiving electromagnetic radiation that may be connected to one or more a wireless data link and/or cellular telephone transceiver 816 coupled to the processor 802. The wireless device 800 may also include physical buttons 812a and 812b for receiving user inputs. The wireless device 800 may also include a power button 818 for turning the wireless device 800 on and off. The wireless device 800 may also include one or more ports 824 coupled to the processor 802 for establishing data connections to various auxiliary devices (e.g., external displays, projectors, additional speakers, etc.), such as a USB or FireWire® connector sockets, or other network connection circuits for coupling the processor 802 to a network.

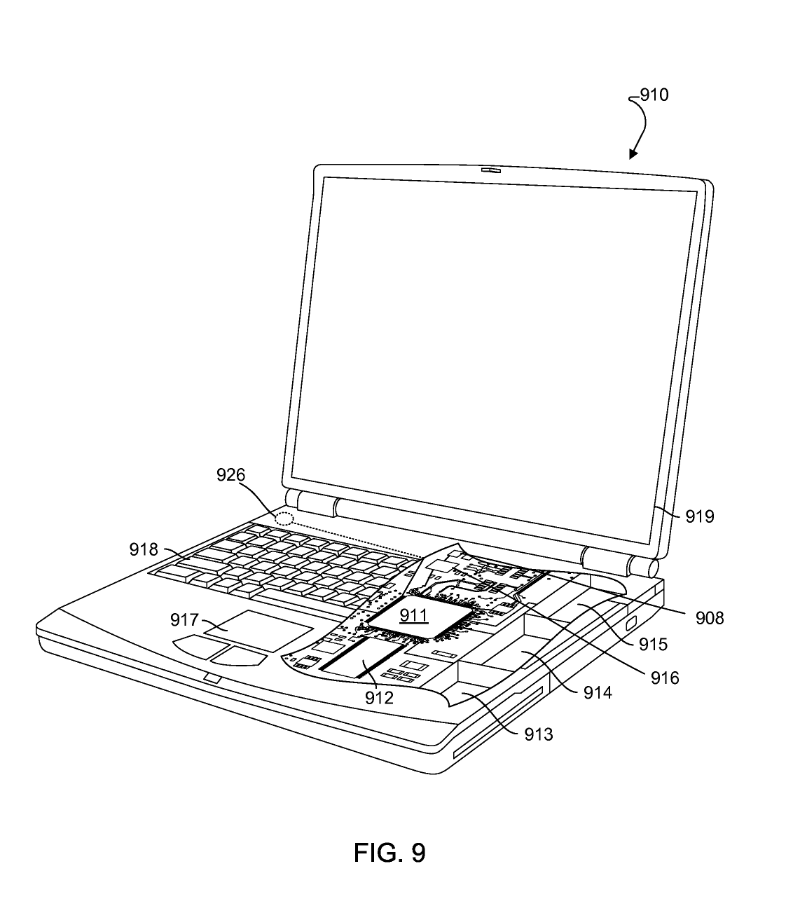

The various embodiments described above may also be implemented within a variety of personal computing devices, such as a laptop computer 910 as illustrated in FIG. 9. Many laptop computers include a touch pad touch surface 917 that serves as the computer's pointing device, and thus may receive drag, scroll, and flick gestures similar to those implemented on mobile computing devices equipped with a touch screen display and described above. A laptop computer 910 will typically include a processor 911 coupled to volatile memory 912 and a large capacity nonvolatile memory, such as a disk drive 913 of Flash memory. The laptop computer 910 may also include a floppy disc drive 914 and a compact disc (CD) drive 915 coupled to the processor 911. The laptop computer 910 may also include one or more ports 926 coupled to the processor 911 for establishing data connections to various auxiliary devices (e.g., external displays, projectors, additional speakers, etc.), such as a USB or FireWire® connector sockets, or other network connection circuits for coupling the processor 910 to a network. In a notebook configuration, the computer housing includes the touchpad 917, the keyboard 918, and the display 919 all coupled to the processor 911. Additionally, the laptop computer 910 may have one or more antenna 908 for sending and receiving electromagnetic radiation that may be connected to one or more a wireless data link and/or cellular telephone transceiver 916 coupled to the processor 911. Other configurations of the computing device may include a computer mouse or trackball coupled to the processor (e.g., via a USB input) as are well known, which may also be used in conjunction with the various embodiments.

The processors 802 and 911 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 804, 810, 912, and 913 before they are accessed and loaded into the processors 802 and 911. The processors 802 and 911 may include internal memory sufficient to store the application software instructions. In many devices the internal memory may be a volatile or nonvolatile memory, such as flash memory, or a mixture of both. For the purposes of this description, a general reference to memory refers to memory accessible by the processors 802 and 911 including internal memory or removable memory plugged into the device and memory within the processor 802 and 911 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for managing the presentation of media on a computing device during a group communication session, comprising:
receiving media data in the computing device during the group communication session, the media data including an identifier of a sender (sender ID) of the media and data useful for presentation of the media;
identifying in the computing device the sender ID associated with the received media data;
identifying in the computing device a presentation rule associated with the sender ID;
selecting an interface of the computing device for presenting the media based on the identified presentation rule; and
presenting the media via the selected interface of the computing device.

2. The method of claim 1, further comprising:
identifying a media type of the received media data in the computing device,
wherein identifying in the computing device a presentation rule associated with the sender ID comprises identifying in the computing device a presentation rule associated with the sender ID and the media type.

3. The method of claim 2, wherein the presentation rule is user configurable, the method further comprising:
receiving a user input; and
configuring the presentation rule in response to the user input.

4. The method of claim 3, wherein receiving a user input and configuring the presentation rule in response to the user input are accomplished during the group communication session.

5. The method of claim 4, wherein the interface is one or more of a display, an ear phone, a speakerphone, a port, an application, and an auxiliary device.

6. The method of claim 2, further comprising:
storing an indication of the selected interface of the computing device used to present the media;
updating the identified presentation rule based at least in part on the stored indication of the selected interface to generate an updated presentation rule;
receiving new media data in the computing device during the group communication session, the new media data including another identifier of the sender (another sender ID);
identifying in the computing device the another sender ID associated with the received new media data;
identifying a new media type of the received new media data in the computing device;
identifying in the computing device the updated presentation rule associated with the another sender ID and the new media type;
selecting another interface of the computing device for presenting the new media based on the identified updated presentation rule; and
presenting the new media via the selected another interface of the computing device.

7. The method of claim 2, wherein the media type is one or more of a picture, a text message, a video, a sound, a multi-purpose internet mail extension (MIME), a resolution, a format, and a file extension.

8. The method of claim 1, further comprising:
sending an indication of the selected interface of the computing device for presenting the media from the computing device to a computing device associated with a sender associated with the identified sender ID.

9. The method of claim 1, further comprising:
sending an indication of the selected interface of the computing device for presenting the media from the computing device to all other computing devices participating in the group communication session.

10. A computing device, comprising:
means for receiving media data in the computing device during a group communication session, the media data including an identifier of a sender (sender ID) of media and data useful for presentation of the media;
means for identifying in the computing device the sender ID associated with the received media data;
means for identifying in the computing device a presentation rule associated with the sender ID;
means for selecting an interface of the computing device for presenting the media based on the identified presentation rule; and
means for presenting the media via the selected interface of the computing device.

11. The computing device of claim 10, further comprising:
means for identifying a media type of the received media data in the computing device,
wherein means for identifying in the computing device a presentation rule associated with the sender ID comprises means for identifying in the computing device a presentation rule associated with the sender ID and the media type.

12. The computing device of claim 11, wherein the presentation rule is user configurable, the computing device further comprising:
means for receiving a user input; and
means for configuring the presentation rule in response to the user input.

13. The computing device of claim 12, wherein:
means for receiving a user input comprises means for receiving a user input during the group communication session; and
means for configuring the presentation rule in response to the user input comprises means for configuring the presentation rule in response to the user input during the group communication session.

14. The computing device of claim 13, wherein the interface is one or more of a display, an ear phone, a speakerphone, a port, an application, and an auxiliary device.

15. The computing device of claim 11, further comprising:
means for storing an indication of the selected interface of the computing device used to present the media;
means for updating the identified presentation rule based at least in part on the stored indication of the selected interface to generate an updated presentation rule;
means for receiving new media data in the computing device during the group communication session, the new media data including another identifier of the sender (another sender ID);
means for identifying in the computing device the another sender ID associated with the received new media data;
means for identifying a new media type of the received new media data in the computing device;
means for identifying in the computing device the updated presentation rule associated with the another sender ID and the new media type;
means for selecting another interface of the computing device for presenting the new media based on the identified updated presentation rule; and
means for presenting the new media via the selected another interface of the computing device.

16. The computing device of claim 11, wherein the media type is one or more of a picture, a text message, a video, a sound, a multi-purpose internet mail extension (MIME), a resolution, a format, and a file extension.

17. The computing device of claim 10, further comprising:
means for sending an indication of the selected interface of the computing device for presenting the media from the computing device to a computing device associated with a sender associated with the identified sender ID.

18. The computing device of claim 10, further comprising:
means for sending an indication of the selected interface of the computing device for presenting the media from the computing device to all other computing devices participating in the group communication session.

19. A computing device, comprising:
a memory; and
a processor coupled to the memory, wherein the processor is configured with processor-executable instructions to perform operations comprising:
receiving media data in the computing device during a group communication session, the media data including an identifier of a sender (sender ID) of media and data useful for presentation of the media;
identifying in the computing device the sender ID associated with the received media data;
identifying in the computing device a presentation rule associated with the sender ID;
selecting an interface of the computing device for presenting the media based on the identified presentation rule; and
presenting the media via the selected interface of the computing device.

20. The computing device of claim 19, wherein the processor is configured with processor-executable instructions to perform operations further comprising:
identifying a media type of the received media data in the computing device,
wherein identifying in the computing device a presentation rule associated with the sender ID comprises identifying in the computing device a presentation rule associated with the sender ID and the media type.

21. The computing device of claim 20, wherein the processor is configured with processor-executable instructions such that the presentation rule is user configurable, and
wherein the processor is configured with processor-executable instructions to perform operations further comprising
receiving a user input; and
configuring the presentation rule in response to the user input.

22. The computing device of claim 21, wherein the processor is configured with processor-executable instructions such that receiving a user input and configuring the presentation rule in response to the user input are accomplished during the group communication session.

23. The computing device of claim 22, wherein the processor is configured with processor-executable instructions such that the interface is one or more of a display, an ear phone, a speakerphone, a port, an application, and an auxiliary device.

24. The computing device of claim 20, wherein the processor is configured with processor-executable instructions to perform operations further comprising:
storing an indication of the selected interface of the computing device used to present the media;
updating the identified presentation rule based at least in part on the stored indication of the selected interface to generate an updated presentation rule;
receiving new media data in the computing device during the group communication session, the new media data including another identifier of the sender (another sender ID);
identifying in the computing device the another sender ID associated with the received new media data;
identifying a new media type of the received new media data in the computing device;
identifying in the computing device the updated presentation rule associated with the another sender ID and the new media type;
selecting another interface of the computing device for presenting the new media based on the identified updated presentation rule; and
presenting the new media via the selected another interface of the computing device.

25. The computing device of claim 20, wherein the processor is configured with processor-executable instructions to perform operations such that the media type is one or more of a picture, a text message, a video, a sound, a multi-purpose internet mail extension (MIME), a resolution, a format, and a file extension.

26. The computing device of claim 19, wherein the processor is configured with processor-executable instructions to perform operations further comprising:
sending an indication of the selected interface of the computing device for presenting the media from the computing device to a computing device associated with a sender associated with the identified sender ID.

27. The computing device of claim 19, wherein the processor is configured with processor-executable instructions to perform operations further comprising:
sending an indication of the selected interface of the computing device for presenting the media from the computing device to all other computing devices participating in the group communication session.

28. A non-transitory computer-readable storage medium having stored thereon processor-executable instructions configured to cause a processor to perform operations comprising:
receiving media data in a computing device during a group communication session, the media data including an identifier of a sender (sender ID) of media and data useful for presentation of the media;
identifying in the computing device the sender ID associated with the received media data;
identifying in the computing device a presentation rule associated with the sender ID;
selecting an interface of the computing device for presenting the media based on the identified presentation rule; and
presenting the media via the selected interface of the computing device.

29. The non-transitory computer-readable storage medium of claim 28, wherein the stored processor-executable instructions are configured to cause a processor to perform operations further comprising:
identifying a media type of the received media data in the computing device,
wherein identifying in the computing device a presentation rule associated with the sender ID comprises identifying in the computing device a presentation rule associated with the sender ID and the media type.

30. The non-transitory computer-readable storage medium of claim 29, wherein the stored processor-executable instructions are configured to cause a processor to perform operations such that the presentation rule is user configurable, and
wherein the stored processor-executable instructions are configured to cause a processor to perform operations further comprising:
receiving a user input; and
configuring the presentation rule in response to the user input.

31. The non-transitory computer-readable storage medium of claim 30, wherein the stored processor-executable instructions are configured to cause a processor to perform operations such that receiving a user input and configuring the presentation rule in response to the user input are accomplished during the group communication session.

32. The non-transitory computer-readable storage medium of claim 31, wherein the stored processor-executable instructions are configured to cause a processor to perform operations such that the interface is one or more of a display, an ear phone, a speakerphone, a port, an application, and an auxiliary device.

33. The non-transitory computer-readable storage medium of claim 29, wherein the stored processor-executable instructions are configured to cause a processor to perform operations further comprising:
storing an indication of the selected interface of the computing device used to present the media;
updating the identified presentation rule based at least in part on the stored indication of the selected interface to generate an updated presentation rule;
receiving new media data in the computing device during the group communication session, the new media data including another identifier of the sender (another sender ID);
identifying in the computing device the another sender ID associated with the received new media data;
identifying a new media type of the received new media data in the computing device;
identifying in the computing device the updated presentation rule associated with the another sender ID and the new media type;
selecting another interface of the computing device for presenting the new media based on the identified updated presentation rule; and
presenting the new media via the selected another interface of the computing device.

34. The non-transitory computer-readable storage medium of claim 29 wherein the stored processor-executable instructions are configured to cause a processor to perform operations such that the media type is one or more of a picture, a text message, a video, a sound, a multi-purpose internet mail extension (MIME), a resolution, a format, and a file extension.

35. The non-transitory computer-readable storage medium of claim 28 wherein the stored processor-executable instructions are configured to cause a processor to perform operations further comprising:
sending an indication of the selected interface of the computing device for presenting the media from the computing device to a computing device associated with a sender associated with the identified sender ID.

36. The non-transitory computer-readable storage medium of claim 28 wherein the stored processor-executable instructions are configured to cause a processor to perform operations further comprising:
sending an indication of the selected interface of the computing device for presenting the media from the computing device to all other computing devices participating in the group communication session.
